(19) United States
(12) Patent Application Publication
(10) Pub. No.: US 2003/0051892 A1
(43) Pub. Date: Mar. 20, 2003

(54) CABLE CHANNEL ASSEMBLY

(76) Inventors: Michael Mattei, Saint James, NY (US); Robert P. Auteri, Manorville, NY (US)

Correspondence Address: W. Thad Adams, III, Adams, Schwartz & Evans, P.A., 2180 Two First Union Center, Charlotte, NC, 28282, US

(21) Appl. No.: 09/954,097

(22) Filed: Sep. 14, 2001

(51) Int. Cl. H02G 3/04

(52) U.S. Cl. 174/48

(57) ABSTRACT

A cable channel assembly for transitioning cables between first and second planes, and comprising a cable channel segment for being attached in a first plane orientation to a cable raceway positioned a second plane orientation in cable communication therewith for permitting cables to pass between the cable raceway and the attached cable channel segment, and at least one cable exit port extending through a first longitudinally-extending wall of the cable channel segment and adapted to permit the cables to exit the cable channel segment. The cable exit port includes radiused cable-supporting surfaces extending around the periphery of both an interior and exterior side of the first longitudinally-extending wall whereby the cable is supported on a radius on the interior of and exterior to the cable channel segment as the cable exits the cable channel segment.

### TECHNICAL FIELD AND BACKGROUND OF THE INVENTION

This invention relates to a cable channel assembly, and a cable channel assembly and raceway outlet combination which have particular application in the operation of fiber optic cable telecommunication systems. These systems can also be used in any system where it is necessary to route flexible cables of any type. Fiber optic cable management often requires that fiber optic cables be routed between fiber optic distribution equipment and, for example, fiber optic line terminating equipment in buildings and other structures. Fiber optic cables are susceptible to damage if bent or crimped beyond a certain point. Standards have evolved which govern the degree of bend radius permitted in fiber optic cables of specified sizes.

Fiber optic cables are thus routed along raceways which are designed to protect the cable from damage while permitting access for modification, maintenance, connection and repair. These raceways are typically top-opening plastic troughs similar in configuration to rain gutters into which the cables are placed and along which the cables run from point-to-point. Fiber optic cables generally exit the raceway over one of the side walls and thus provision must be made to guide and support the cable to prevent damage from bending or crimping at this point of exit. These raceways are often placed in or near ceilings. This practice makes use of space otherwise wasted, places the cables out of the way of other equipment and minimizes handling and inadvertent damage. Not only must the cables be safely and efficiently handled along raceways between various types of equipment, but must also be carefully routed out of the horizontal raceways and to equipment normally positioned on the floor of, for example, a studio, telephone central office, cable television system equipment room, and the like. This requires removing the cables from the overhead, horizontal raceways and dropping them to the equipment to which the cables will be connected. Many of the same considerations apply here as apply in routing the cables through the raceways. The cables must not be overbent, and should exit the protected confines of the raceway or other protective conduit as close to the point of connection as possible so as to minimize exposure to damage. The means for routing the cables from the overhead raceways to equipment for connection should also be adaptable to many sizes and numbers of cables and should be easily accessible for installation, removal and repair of the cables.

This invention provides a simple and inexpensive means of channeling cables out of a raceway and to an equipment connection. The channel according to the invention is easily moveable, adaptable to many different raceway sizes and configurations, and provides all necessary support and bend restrictions to the cable. The channel provides full protection by enclosing the cable, while permitting easy access to the channel when laying new cable or removing or repairing existing cable. The channels provide full radius protection to the cable.

In addition, the channels are adapted to mate with different brands of outlets which route the cables over the side of the raceway without requiring any modification to the raceway itself.

### SUMMARY OF THE INVENTION

Therefore, it is an object of the invention to provide a cable channel which routes cables from raceways, such as overhead raceways, and to equipment connection points.

It is another object of the invention to provide a cable channel which is adapted to be used with different brands of cable raceways.

It is another object of the invention to provide a cable channel which is modular.

It is another object of the invention to provide a cable channel which provides exit ports with radius protection for the cables carried in the channel.

It is another object of the invention to provide a cable channel which utilizes many components in common with different sizes.

These and other objects of the present invention are achieved in the preferred embodiments disclosed below by providing a cable channel assembly for transitioning cables between first and second planes, and comprising a cable channel segment for being attached in a first plane orientation to a cable raceway positioned a second plane orientation in cable communication therewith for permitting cables to pass between the cable raceway and the attached cable channel segment, and at least one cable exit port extending through a first longitudinally-extending wall of the cable channel segment and adapted to permit the cables to exit the cable channel segment. The cable exit port includes radiused cable-supporting surfaces extending around the periphery of both an interior and exterior side of the first longitudinally-extending wall whereby the cable is supported on a radius on the interior of and exterior to the cable channel segment as the cable exits the cable channel segment.

According to one preferred embodiment of the invention, each cable channel segment includes a plurality of adjacent cable exit ports, each of the cable exit ports including radiused cable-supporting surfaces extending around the periphery of inner and outer walls defining the cable outlet segment.

According to another preferred embodiment of the invention, the first plane orientation comprises the vertical plane and the second plane orientation comprises the horizontal plane.

According to yet another preferred embodiment of the invention, the cable channel segment includes a cable access opening extending along a second longitudinally-extending wall, and a cover for being removably positioned over the cable access opening for permitting access to the interior of the cable channel segment when removed and for protecting the interior of the cable channel segment when in position over the cable access opening.

According to yet another preferred embodiment of the invention, the cable channel segment includes complementary attachment members positioned on opposite ends for permitting a plurality of the cable channel segments to be joined together to form a single cable channel of a predetermined length through which the cables pass.

According to yet another preferred embodiment of the invention, each cable channel segment includes a plurality of adjacent cable exit ports. Each of the cable exit ports includes radiused cable-supporting surfaces extending around the periphery of inner and outer walls defining the cable outlet segment. The plurality of adjacent cable exit ports are formed in a single elongate panel adapted for being positioned in an correspondingly-sized elongate opening in the first longitudinallyextending wall of the cable channel segment.

According to yet another preferred embodiment of the invention, each cable exit port includes a slot formed therein communicating with the inner and outer walls defining the cable outlet segment for permitting the cables to be positioned within a cable exit port without passing the end of the cable therethrough.

According to yet another preferred embodiment of the invention, an elongate cover is provided for being releasably attached to and enclosing the interior of the cable channel segment and the slot in the cable exit ports.

According to yet another preferred embodiment of the invention, modular cable retainers are provided for retaining the cable within the cable channel segment, wherein the cable retainers comprise complementary tabs positioned on opposing walls of the cable channel segment defining the cable access opening and extending towards each other to define a cable retainer opening therebetween.

According to yet another preferred embodiment of the invention, a cable raceway outlet and channel assembly mountable in relation to a cable raceway is provided. The cable raceway has a side wall terminating in a top edge. The raceway outlet and channel assembly comprises a transition assembly for being mounted over the top of the top edge of the raceway for supporting a cable passing between the raceway and a point outside the raceway. A clamping member is carried by the transition assembly for contacting one of an inner or an outer surface of the side wall. A latching member is carried by the transition assembly for contacting the other of the inner or outer surface of the side wall. The latching member is adapted for movement between a clamping position wherein the latching member and the clamping member are urged towards each other and against respective surfaces of the raceway sidewalls thereby clamping the side wall of the raceway between the latching member and the clamping member and a release position wherein the latching member and the clamping member are spaced-apart from each other sufficiently to permit the transition assembly to be removed from, placed on or moved along the length of the raceway. A cable channel assembly is provided for transitioning cables between first and second planes, and comprises a cable channel segment for being attached in a first plane orientation to a cable raceway positioned a second plane orientation in cable communication therewith for permitting cables to pass between the cable raceway and the attached cable channel, and at least one cable exit port formed in the cable channel and adapted to permit the cables to exit the cable channel. The cable exit port includes radiused cable-supporting surfaces extending around the periphery of both an interior and exterior side of the first longitudinally-extending wall, whereby the cable is supported on a radius on the interior of and exterior to the cable channel segment as the cable exits the cable channel segment.

According to yet another preferred embodiment of the invention, the latching member comprises a pivot member extending along a length of the clamping member, and a cam mounted for pivotable movement on the pivot member between the clamping position wherein the cam is pivoted into an extended position against the sidewall of the raceway and the release position wherein the cam is pivoted into a retracted position in space-apart relation to the side wall of the raceway.

According to yet another preferred embodiment of the invention, a finger grip is carried by the cam for facilitating manual operation of the cam between the extended and release positions.

According to yet another preferred embodiment of the invention, the transition assembly includes at least one curved cable support wall for being positioned above the top edge of the raceway.

According to yet another preferred embodiment of the invention, the transition assembly includes first and second curved cable support walls for being positioned above the top edge of the raceway. The first curved wall is defined by a radius perpendicular to a longitudinal dimension of the cable raceway, and the second curved wall is defined by a radius parallel to the longitudinal dimension of the cable raceway.

According to yet another preferred embodiment of the invention, an enlarged void is defined by a wall of the transition assembly, the latching assembly and the clamping assembly for accommodating the top edge of cable raceways having an enlarged lip extending along the length of the top edge.

According to yet another preferred embodiment of the invention, the clamping member is positioned within the cable raceway for contacting the inner surface of the side wall, and the latching member is positioned outside the cable raceway for contacting the outer surface of the side wall.

According to yet another preferred embodiment of the invention, the transition assembly includes a plurality of parallel walls defining individual exit paths for individual cables or cable groups.

According to yet another preferred embodiment of the invention, the transition assembly includes a protective transition assembly cover for being positioned onto the transition assembly for enclosing the cable passing between the raceway and a point outside the raceway

According to yet another preferred embodiment of the invention, a raceway cover is carried by the transition assembly cover for covering a top opening of the raceway defined by the side wall and a second, laterally spaced-apart side wall.

According to yet another preferred embodiment of the invention, the raceway cover is pivotally-mounted for movement between an open position allowing access to the raceway and a closed position covering the top opening of the raceway.

According to yet another preferred embodiment of the invention, each cable channel segment includes a plurality of adjacent cable exit ports and each of the cable exit ports including radiused cable-supporting surfaces extending around the periphery of both an interior and exterior side of the first longitudinally-extending wall. The cable is therefore supported on a radius on the interior of and exterior to the cable channel segment as the cable exits the cable channel segment.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a perspective view of a cable channel assembly according to an embodiment of the invention;

FIG. 2 is a perspective view of a cable channel assembly according to the embodiment of the invention shown in FIG. 1 with the cover removed;

FIG. 3 is a perspective view of the back side of a cable channel assembly according to the embodiment of the invention shown in FIG. 1;

FIG. 4 is a side elevation of one side of the cable channel assembly of FIG. 1;

FIG. 5 is a cross-section of the cable channel assembly of FIG. 1, showing the profile of the exit ports;

FIG. 6 is a end elevation of the cable channel assembly of FIG. 1;

FIG. 7 is an exploded view of the cable channel assembly of FIG. 1;

FIG. 8 is an exploded view of an alternative embodiment of a cable channel assembly according to the invention;

FIG. 9 is a perspective view of the cable channel assembly shown in FIG. 8;

FIG. 10 is a side elevation of the side of the cable channel assembly of FIG. 8 having the exit ports;

FIG. 11 is an exploded view of a further alternative embodiment of a cable channel assembly according to the invention;

FIG. 12 is a perspective view of the cable channel assembly shown in FIG. 8 with the cover removed;

FIG. 13 is a fragmentary perspective view of the cable channel assembly according to FIGS. 1-7 mounted on a raceway outlet attached to a cable raceway;

FIG. 14 is a fragmentary perspective view of the cable channel assembly according to FIG. 13 with the cover of the transition connector removed; and

FIG. 15 is a side elevation of a cable channel assembly according to FIGS. 1-7 mounted on a raceway outlet attached to a cable raceway.

### DESCRIPTION OF THE PREFERRED EMBODIMENT AND BEST MODE

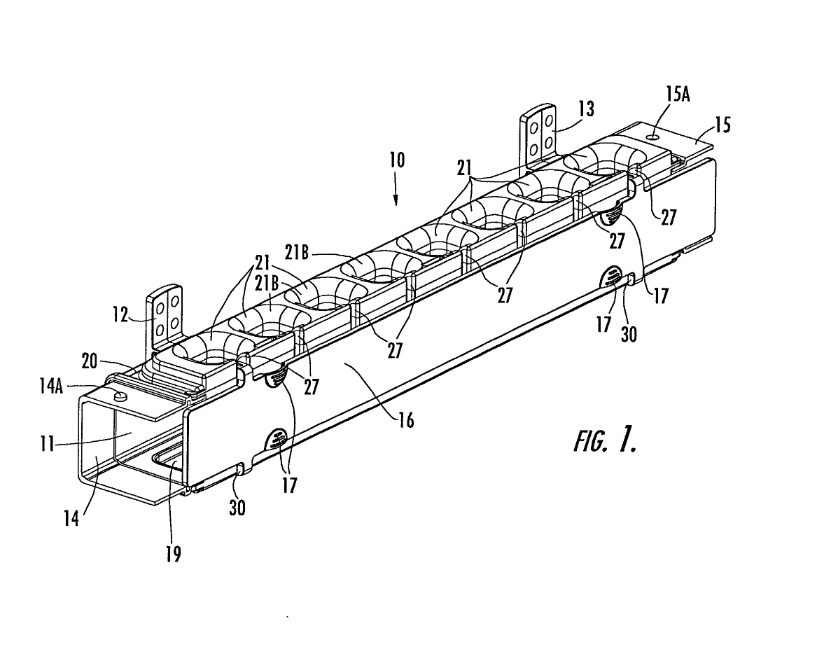

Referring now specifically to the drawings, a cable channel assembly according to the present invention is illustrated in FIG. 1 and shown generally at reference numeral 10. Ordinarily the cable channel assembly 10 will be used to house cables, such as fiber optic cables, which are being transitioned from a cable raceway, as described in further detail below. In general, the cable channel assembly 10 and its parts are modular and made to snap together and apart without tools. Mounting is accomplished without intrusion of fasteners or fastener elements into the units. The elements are formed of a suitable plastic material, and can be molded by any suitable process. The cable channel assembly 10 can be described in a number of ways, for example, as a “cable manager”, or as a “vertical drop.” In general, the cable channel assembly 10 is used to “drop” cables in an organized, controlled manner from an overhead horizontal raceway vertically to equipment which the cables interconnect to a remote device. However, the cable channel assembly 10 can be used in other orientations than vertical.

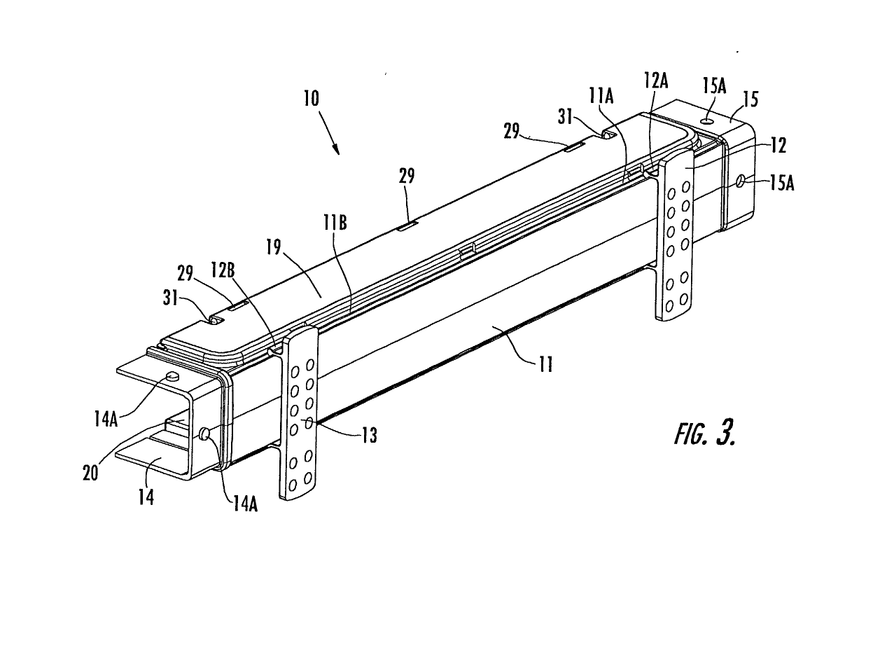

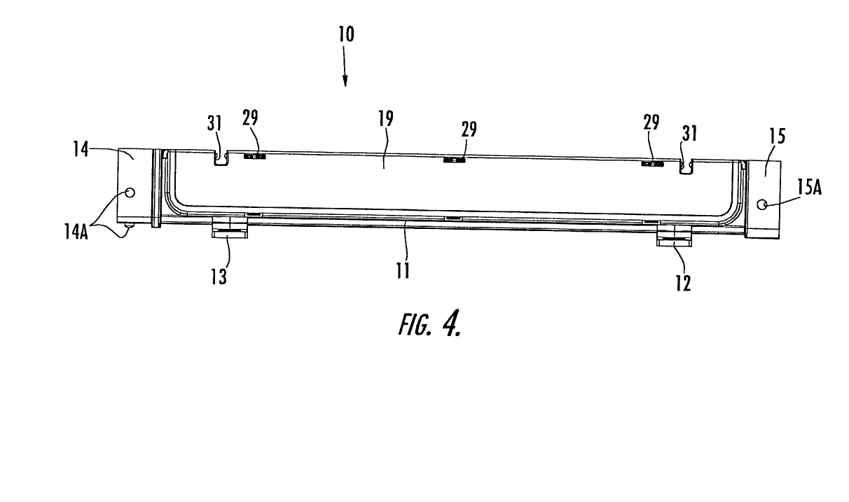

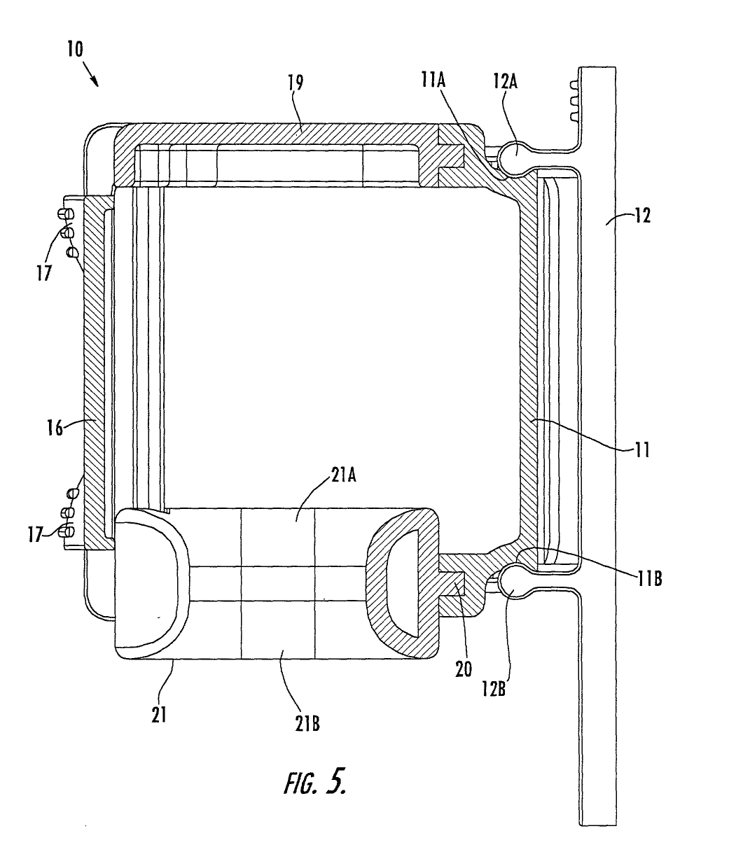

The cable channel assembly 10 includes a U-shaped channel segment 11 having mounted thereon at pair of brackets 12, 13 by which the channel segment 11 is mounted to a supporting surface such as a wall, post, equipment rack, or other support. The particular embodiment of the channel assembly 10 shown in FIGS. 1-7 has a 2″×2″ (5 cm×5 cm) dimension channel segment 11. As is best shown in FIG. 5, the bracket 12, also representative of bracket 13, includes enlarged press-fit connectors 12A, 12B which snap into mating recesses 11A, 11B in the channel segment 11. Thus, the channel segment 11 may be placed on and removed from the brackets 12, 13 without tools. The bracket recesses 11A, 11B extend the entire length of the channel segment 11, permitting the brackets 12 and 13 to be connected at any suitable place on a supporting surface and still be attachable to the channel segment 11. See FIG. 3.

The cable channel assembly 10 includes a pair of opposed attachment members in the form of three-panel planar attachment flanges 14, 15 which are complementary to like flanges on like cable channel assemblies 10, and which serve to permit the cable channel assembly 10 to be connected together to form runs of a desired length. While the cable channel assembly 10 can be any length, one suitable length is 18″ (46 cm). Each of the three panels of the attachment flange 14 include outwardly-projecting buttons 14A which fits into complementary holes 15A in the three panels of attachment flange 15. Adjacent cable channel assemblies 10 are thus fitted together by overlapping the adjacent flanges 14 and 15 and positioning the buttons 14A of one cable channel assembly 10 in the holes 15A of the adjacent channel segment 15.

The top of the cable channel assembly 10 includes a snap off/snap on cover 16 with raised finger grips 17 which permit the cover 16 to be removed by pulling the cover 16 away from the walls of the channel segment 11. Both side walls of the channel segment 11 include removable snap in/snap out inserts. These inserts may be either a solid wall insert 19, see FIG. 3, or an exit port insert 20. The exit port insert 20 includes a suitable number of adjacent exit ports 21. The close proximity of the exit port 21 permit the cables to be exited from the cable channel assembly 10 at the closest possible distance from their connection point.

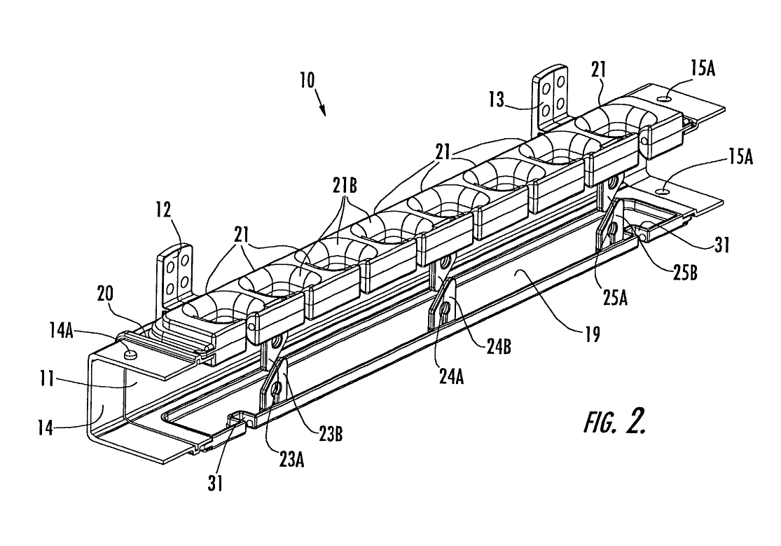

As is shown in FIG. 2, the channel segment 11 includes spaced cable retainers 23A, 23B, 24A, 24B, 25A, 25B which respectively define diagonally-extending openings through which the cables may be passed when placing them in or removing them from the cable channel assembly 10.

The exit ports 21 each include a cable access opening 27 which permit cables to be placed in and removed from respective exit ports 21 when the cover 16 is removed. See FIG. 2. The cover 16 acts as a closure to the cable access opening 27 when in place on the channel segment 11, as is shown in FIG. 1.

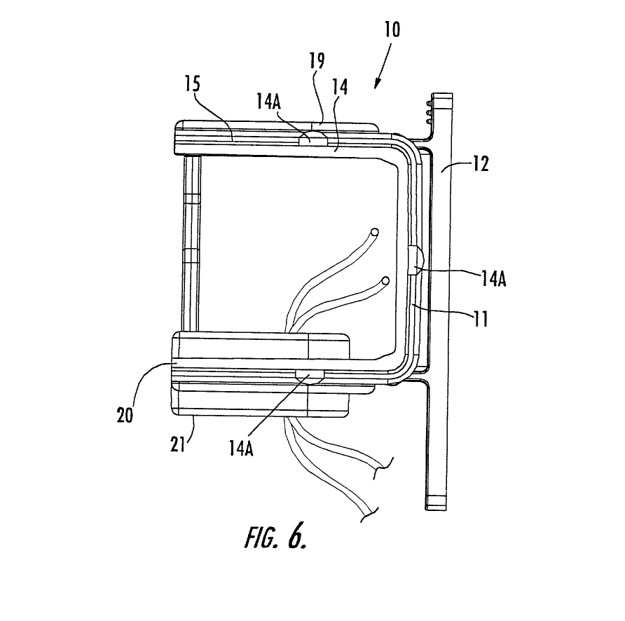

Note particularly that each of the exit ports 21 includes radiused cable-supporting surfaces on both the interior and exterior surfaces relative to the cable channel assembly 10. As is best shown in FIG. 5, the exit port 21, representative of each of the exit ports 21, includes a radiused interior wall 21A and a radiused exterior wall 21B, thus providing curve protection to the cables on both sides of the cable channel assembly 10. See also FIG. 6.

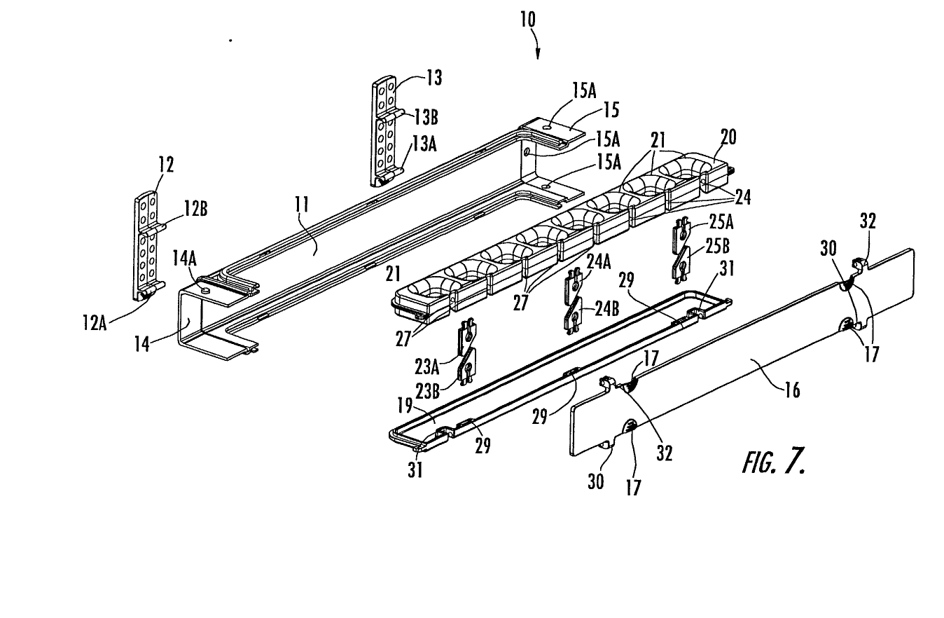

The exploded view of the cable channel assembly 10 shown in FIG. 7 provides further detail and illustrates the modular, snap-together construction of the cable channel assembly 10. Note particularly the anchor recesses 29 in the wall insert for the cable retainers 23B, 24B, 25B, also shown in FIG. 2. Similar anchor recesses, not shown, are formed in the walls of the exit port insert 20 and receive cable retainers 23A, 24A, 25A in the same manner as described above. In addition, note the anchors 30 on cover 16 and the complementary recesses 31 in the sides of wall insert 19 into which anchors 30 snap. Recess anchors 32 are designed to fit within the cable access openings 27 of the exit ports 21 on opposing ends of the cable channel assembly 10. See also FIG. 1. Although not shown, any one or more of the cable channel assemblies 10 making up a complete run may have two exit port wall inserts 20 positioned therein instead of a single exit port insert 20 and a single solid wall insert 19. Likewise, along lengths where it is not necessary to have an exit port insert 20, two solid wall inserts 19 can be provided in specified cable channel assembly 10.

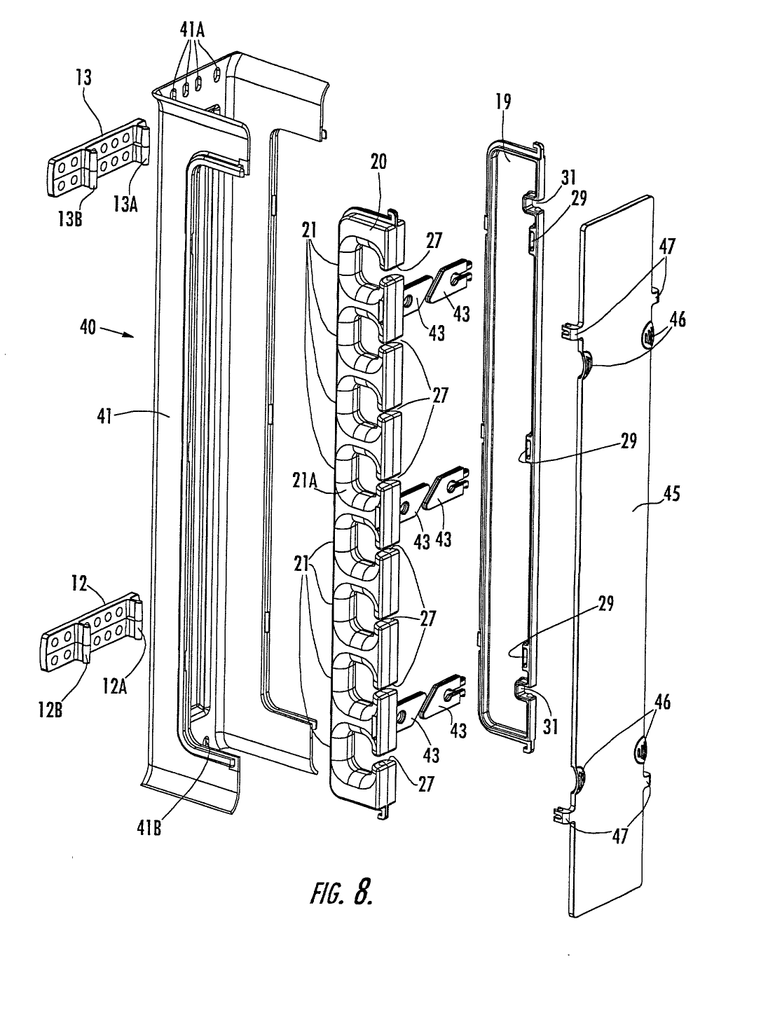

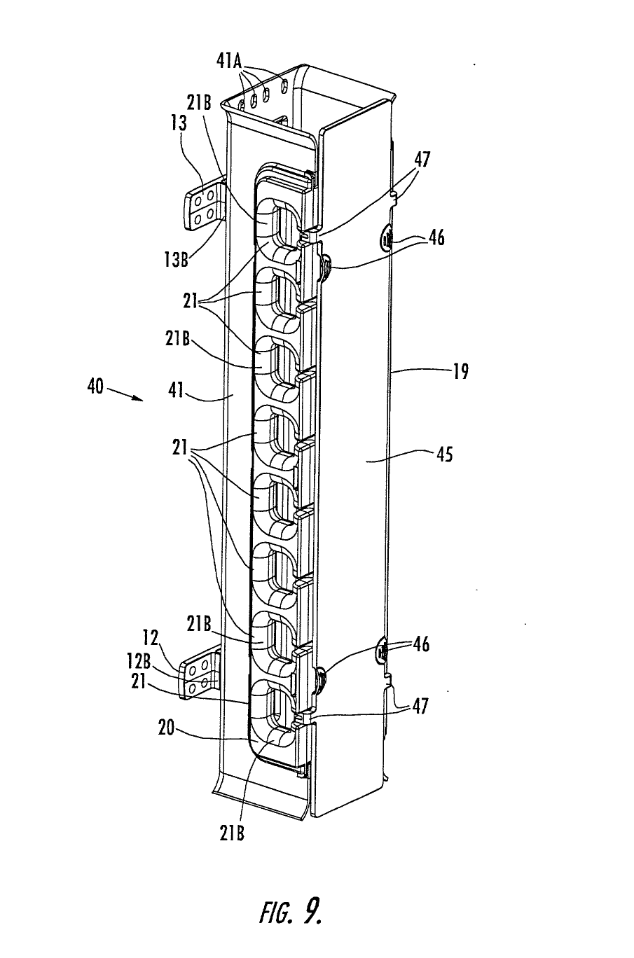

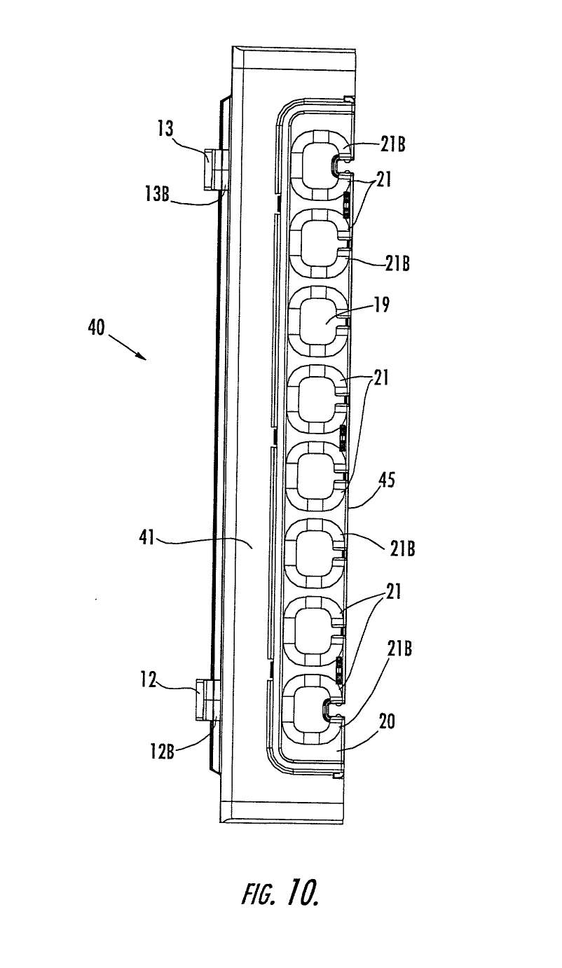

Referring now to FIGS. 8-10, a 3″×3″ (7.6 cm×7.6 cm) version of the cable channel assembly is illustrated and indicated at broad reference numeral 40. As is clearly shown, many of the elements utilized for the cable channel assembly 40 are the same as are used for the cable channel assembly 10. Specifically, the attachment brackets 12, solid wall insert 19 and exit port insert 20 are adaptable to different sized cable channel assemblies, and thus can be used interchangeably by means of complementary snap fittings, as illustrated. Cable retainers 43 are sufficiently longer to accommodate the increased width of the channel segment 31, but function exactly like the cable retainers 23A, 23B, 24A, 24B, 25A, 25B. The channel segment 41 is provided with a backing plate 42 with recesses (not shown) having the same spacing as the recesses 11A, 11B of cable channel assembly 10, permitting the brackets 12 to attach to the channel segment 41 just as with the channel segment 11. Channel segment 41 also includes holes 41A and 41B on opposite ends for being internected with suitable fasteners or with a separate transition flange (not shown).

The cover 45 is provided with finger grips 46 which permit the cover to be removed by pulling the cover away from the walls of the channel segment 11. Recess anchors 47 on cover 45 mate with the complementary recesses 31 in the sides of wall insert 19 and with the cable access openings 27 of the exit ports 21 on opposing ends of the channel segment 41.

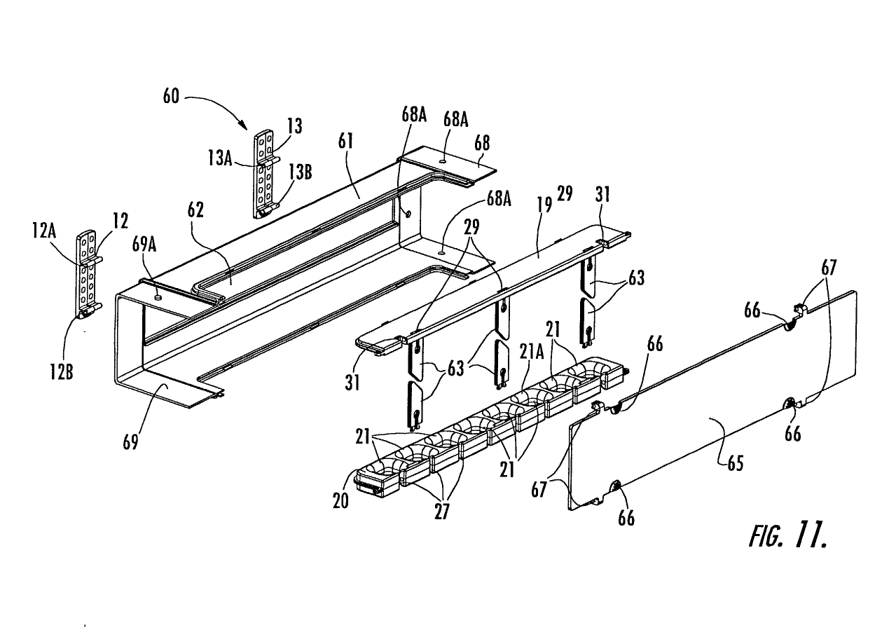

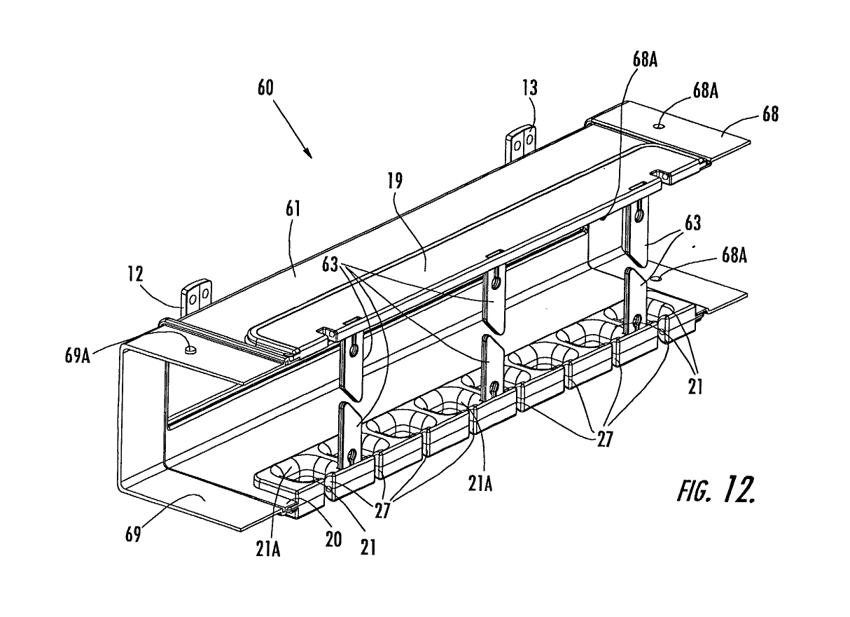

Referring now to FIGS. 11-12, a 4″×4″ (10 cm×10 cm) version of the channel assembly is illustrated at broad reference numeral 60. As is clearly shown, many of the elements utilized for the cable channel assembly 60 are the same as are used for the cable channel assemblies 10 and 40. Specifically, the attachment brackets 12, solid wall insert 19, and the exit port insert 20 adaptable to different sized cable channel assemblies, and thus can be used interchangeably. The channel segment 61 is provided with a backing plate 62 with recesses (not shown) having the same spacing as the recesses 11A, 11B of cable channel assembly 10, permitting the brackets 12 to attach to the channel segment 61 in the same manner as to channel segment 11. Cable retainers 63 are sufficiently long to accommodate the increased width of the cable channel assembly 60.

Three-panel attachment flanges 68 and 69 permit attachment of a particular cable channel assembly 60 to additional like channel assemblies 60 by means of buttons 69A which are positioned in complementary holes 68A in flange 68.

The cover 65 is provided with finger grips 66 which permit the cover to be removed by pulling the cover away from the walls of the channel segment 11. Recess anchors 67 on cover 65 mate with the complementary recesses 31 in the sides of wall insert 19 and with the cable access openings 27 of the exit ports 21 on opposing ends of the channel segment 61.

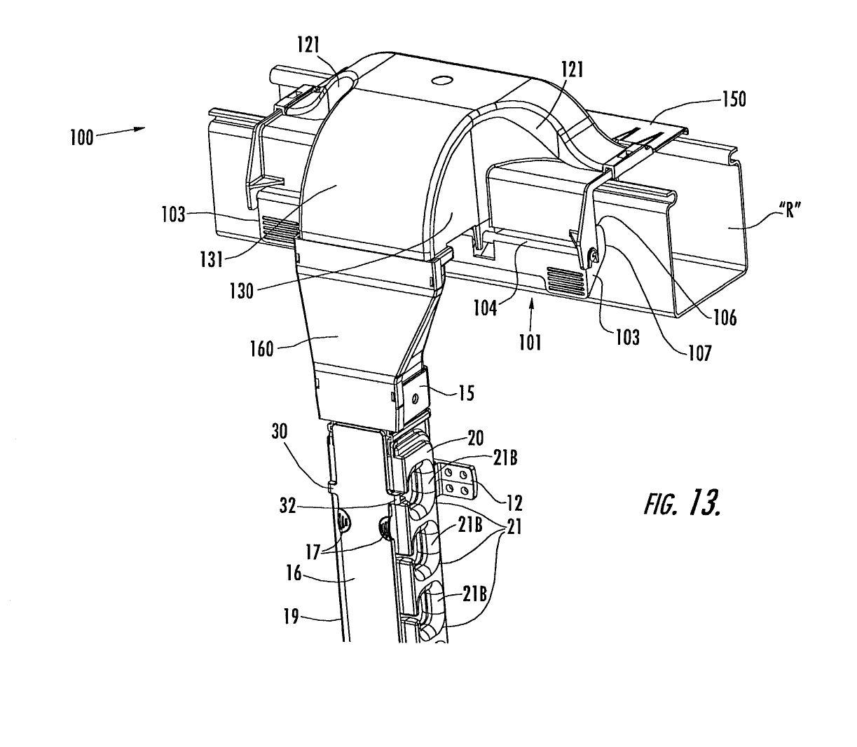

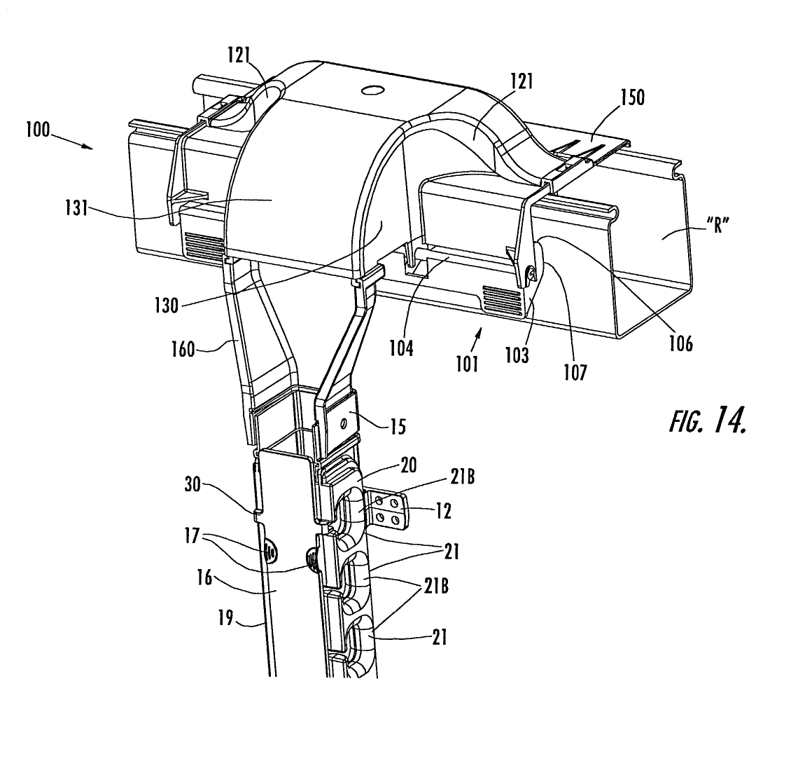

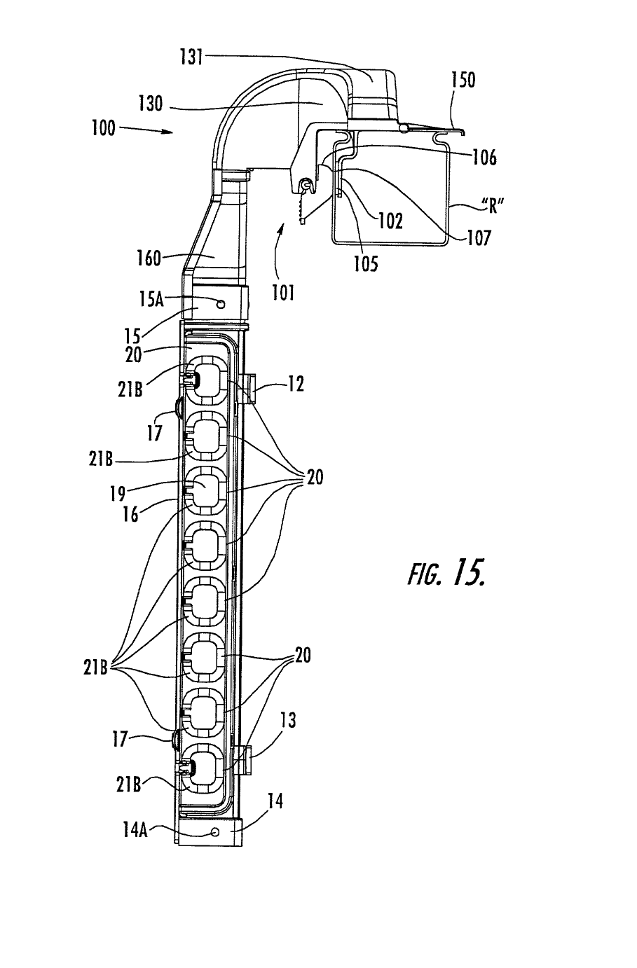

Referring now to FIGS. 13-15, the manner of use of the cable channel assembly 10 is illustrated and described. A cable raceway outlet according to the present invention is shown generally at reference numeral 100. The cable raceway outlet 100 is designed to sit on top of and straddle one side wall of a cable raceway, such as raceway “R”. The cable raceway outlet 100 may be made in any size to accommodate different size raceways. Two typical-sized raceways with which the cable raceway outlet 100 is useable are four-inch by four-inch and four-inch by eight-inch raceways. In general, the cable raceway outlet 100 is symmetrical side-to-side, so that reference to a pair of elements on opposite ends of the cable raceway outlet 100 is understood as referring to identical elements unless otherwise stated.

The cable raceway outlet 100 is constructed of molded, high-impact plastic which conforms to industry standards. Cable raceway outlet 100 includes a bracket assembly 101 by which it is attached to a raceway. Bracket assembly 101 includes a pair of clamping members 102 on opposite ends of the cable raceway outlet 100 which cooperate with latching members 103 integrally formed on a pivotable latch arm 104 which extends the length of the cable raceway outlet 10. A pair of pads 105 carried on respective clamping members 102 provide improved adherence to the raceway and additional resilience during and after latching.

The latching members 103 have a curved face 106 which acts as a cam and bears against and moves along the outer sidewall of the raceway until it moves past an overcenter point, where it snaps into position with a flat face 107 flush in a latched position against the outer side wall with the outer sidewall pinched between the latching members 103 and the clamping members 102. This requires no tools and no alteration to the raceway. Precise adjustment and readjustment is possible merely by releasing the latching members 103 by pulling upwardly on the latching members 103 and thereby forcing the curved face 106 downwardly along the outer side wall of the raceway until it reaches a release position with the latching members 103 in an approximate 90 degree position to the position shown in FIGS. 13-15. In this position the cable raceway outlet 100 is removable by lifting it off of the raceway “R”, or laterally adjustable by sliding it along the raceway “R” to the desired position. This is a particularly useful feature, since it allows initial placement in the approximately correct position, and subsequent adjustment to the exact position. Since no cutting or other alteration of the raceway is necessary, adjustments of any degree can be made whenever needed.

An outlet transition assembly 120 is carried on the bracket assembly 11 and includes a pair of transition flanges 121 which guide the fiber optic cable out of the raceway from either direction without excessive bending. The transition flanges 121 guide the cables around a 90 degree bend into a downspout 130 which is normally inclosed by a cover 131 and includes several divider walls (not shown) for maintaining separation between individual cables. The downspout 130 can be mated with several different types of fittings for attachment to different sizes of vertical raceways, terminations or the like.

Cable raceway outlet 100 also includes a hinged raceway cover 150 which is movable between a closed, horizontal position shown in FIG. 13 where it overlaps the top of and encloses the top of the raceway, and on open position with the raceway cover 150 in a vertical position. In the open position, the raceway cover 150 exposes an opening at the top of the raceway, and permits an installer to drop additional cable into the raceway without removing the cable raceway outlet 100 or the cover 131.

As is apparent from the foregoing, the cable raceway outlet 100 can easily be attached to the raceway “R” by placing the raceway outlet 100 over a side wall of the raceway “R” with the clamping members 112 on the inside of the raceway side wall and the latching members 113 on the outside in the open position. With the top edge of the raceway side wall against the top of the bracket assembly 101, the latching members 103 are moved to the position shown in FIG. 13.

Raceway outlet 100 is interconnected to the cable channel assembly 10 by means of a transition fitting 160 which connects to the bottom end of the downspout 130 by the attachment flange 15 as shown in FIGS. 13-15. Cables exiting the raceway “R” through the raceway outlet 100 then drop vertically through the cable channel assembly 10 of appropriate length to a predetermined exit point where they are extended through an appropriately-positioned exit port 21 for connection to equipment.

Cable channel assemblies 40 and 60 are likewise connectable to the raceway outlet 100 by means of a suitably-sized transition fitting attached to the downspout 130.

A cable channel assembly, and a cable channel assembly and raceway outlet combination is described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

We claim:

1. A cable channel assembly for transitioning cables between first and second planes, and comprising:
(a) a cable channel segment for being attached in a first plane orientation to a cable raceway positioned a second plane orientation in cable communication therewith for permitting cables to pass between the cable raceway and the attached cable channel segment; and
(b) at least one cable exit port extending through a first longitudinallyextending wall of said cable channel segment and adapted to permit the cables to exit the cable channel segment, said cable exit port including radiused cable-supporting surfaces extending around the periphery of both an interior and exterior side of said first longitudinally-extending wall, whereby the cable is supported on a radius on the interior of and exterior to the cable channel segment as the cable exits the cable channel segment.

2. A cable channel assembly according to claim 1, wherein each cable channel segment includes a plurality of adjacent cable exit ports, each of said cable exit ports including radiused cable-supporting surfaces extending around the periphery of inner and outer walls defining said cable outlet segment.

3. A cable channel assembly according to claim 1, wherein said first plane orientation comprises the vertical plane and the second plane orientation comprises the horizontal plane.

4. A cable channel assembly according to claim 1, 2 or 3, wherein said cable channel segment includes a cable access opening extending along a second longitudinally-extending wall, and a cover for being removably positioned over the cable access opening for permitting access to the interior of the cable channel segment when removed and for protecting the interior of the cable channel segment when in position over the cable access opening.

5. A cable channel assembly according to claim 1, 2 or 3, wherein said cable channel segment includes complementary attachment members positioned on opposite ends for permitting a plurality of said cable channel segments to be joined together to form a single cable channel of a predetermined length through which the cables pass.

6. A cable channel assembly according to claim 1, wherein each cable channel segment includes a plurality of adjacent cable exit ports, each of said cable exit ports including radiused cable-supporting surfaces extending around the periphery of inner and outer walls defining said cable outlet segment, and further wherein said plurality of adjacent cable exit ports are formed in a single elongate panel adapted for being positioned in an correspondingly-sized elongate opening in the first longitudinally extending wall of the cable channel segment.

7. A cable channel assembly according to claim 6, wherein each cable exit port includes a slot formed therein communicating with the inner and outer walls defining the cable outlet segment for permitting the cables to be positioned within a cable exit without passing the end of the cable therethrough.

8. A cable assembly according to claim 7, and including an elongate cover for being releasably attached to and enclosing the interior of the cable channel segment and the slot in the cable exit ports.

9. A cable channel assembly according to claim 1, and including cable retainers for retaining cable within the cable channel segment, wherein said cable retainers comprise complementary tabs positioned on opposing walls of the cable channel segment defining the cable access opening and extending towards each other to define a cable retainer opening therebetween.

10. A cable raceway outlet and channel assembly mountable in relation to a cable raceway having a side wall terminating in a top edge, said raceway outlet and channel assembly comprising:
(a) a transition assembly for being mounted over the top of the top edge of the raceway for supporting a cable passing between the raceway and a point outside the raceway;
(b) a clamping member carried by the transition assembly for contacting one of an inner or an outer surface of the side wall;
(c) a latching member carried by the transition assembly for contacting the other of the inner or outer surface of the side wall, said latching member adapted for movement between:
(i) a clamping position wherein said latching member and said clamping member are urged towards each other and against respective surfaces of the raceway sidewalls thereby clamping the side wall of the raceway between the latching member and the clamping member;
(ii) a release position wherein said latching member and said clamping member are spaced-apart from each other sufficiently to permit the transition assembly to be removed from, placed on or moved along the length of the raceway;
(d) a cable channel assembly for transitioning cables between first and second planes, and comprising:
(i) a cable channel segment for being attached in a first plane orientation to a cable raceway positioned a second plane orientation in cable communication therewith for permitting cables to pass between the cable raceway and the attached cable channel; and
(ii) at least one cable exit port formed in said cable channel and adapted to permit the cables to exit the cable channel, said cable exit port including radiused cable-supporting surfaces extending around the periphery of both an interior and exterior side of said first longitudinally-extending wall, whereby the cable is supported on a radius on the interior of and exterior to the cable channel segment as the cable exits the cable channel segment.

11. A cable raceway outlet and channel assembly according to claim 10, wherein said latching member comprises:
(a) a pivot member extending along a length of the clamping member; and
(b) a cam mounted for pivotable movement on the pivot member between the clamping position wherein the cam is pivoted into an extended position against the sidewall of the raceway and the release position wherein the cam is pivoted into a retracted position in space-apart relation to the side wall of the raceway.

12. A cable raceway outlet and channel assembly according to claim 10, and including a finger grip carried by the cam for facilitating manual operation of the cam between the extended and release positions.

13. A cable raceway outlet and channel assembly according to claim 12, wherein said transition assembly includes at least one curved cable support wall for being positioned above the top edge of the raceway.

14. A cable raceway outlet and channel assembly according to claim 12, wherein said transition assembly includes first and second curved cable support walls for being positioned above the top edge of the raceway, said first curved wall defined by a radius perpendicular to a longitudinal dimension of the cable raceway, and said second curved wall defined by a radius parallel to the longitudinal dimension of the cable raceway.

15. A cable raceway outlet and channel assembly according to claim 10, and including an enlarged void defined by a wall of the transition assembly, the latching assembly and the clamping assembly for accommodating the top edge of cable raceway having an enlarged lip extending along the length of the top edge.

16. A cable raceway outlet and channel assembly according to claim 10, wherein the clamping member is positioned within the cable raceway for contacting the inner surface of the side wall, and the latching member is positioned outside the cable raceway for contacting the outer surface of the side wall.

17. A cable raceway outlet and channel assembly according to claim 10, wherein said transition assembly includes a plurality of parallel walls defining individual exit paths for individual cables or cable groups.

18. A cable raceway outlet and channel assembly according to claim 10, wherein said transition assembly including a protective transition assembly cover for being positioned onto the transition assembly for enclosing the cable passing between the raceway and a point outside the raceway.

19. A cable raceway outlet and channel assembly according to claim 18, and including a raceway cover carried by the transition assembly cover for covering a top opening of the raceway defined by the side wall and a second, laterally spaced-apart side wall.

20. A cable raceway outlet and channel assembly according to claim 19, wherein said raceway cover is pivotally-mounted for movement between an open position allowing access to the raceway and a closed position covering the top opening of the raceway.

21. A cable raceway outlet and channel assembly according to claim 10, wherein each cable channel segment includes a plurality of adjacent cable exit ports, each of said cable exit ports including radiused cable-supporting surfaces extending around the periphery of both an interior and exterior side of said first longitudinally-extending wall, whereby the cable is supported on a radius on the interior of and exterior to the cable channel segment as the cable exits the cable channel segment.

22. A cable raceway outlet and channel assembly according to claim 10, wherein said first plane orientation comprises the vertical plane and the second plane orientation comprises the horizontal plane.

23. A cable raceway outlet and channel assembly according to claim 10, 11 or 12, wherein said cable channel segment includes a cable access opening extending along a second longitudinally-extending wall, and a cover for being removably positioned over the cable access opening for permitting access to the interior of the cable channel segment when removed and for protecting the interior of the cable channel segment when in position over the cable access opening.

24. A cable raceway outlet and channel assembly according to claim 10, 11 or 12, wherein said cable channel segment includes complementary attachment members positioned on opposite ends for permitting a plurality of said cable channel segments to be joined together to form a single cable channel of a predetermined length through which the cables pass.

25. A cable raceway outlet and channel assembly according to claim 10, wherein each cable channel segment includes a plurality of adjacent cable exit ports, each of said cable exit ports including radiused cable-supporting surfaces extending around the periphery of inner and outer walls defining said cable outlet segment, and further wherein said plurality of adjacent cable exit ports are formed in a single elongate panel adapted for being positioned in an correspondingly-sized elongate opening in the first longitudinally-extending wall of the cable channel segment.

26. A cable raceway outlet and channel assembly according to claim 10, wherein each cable exit port includes a slot formed therein communicating with the inner and outer walls defining the cable outlet segment for permitting the cables to be positioned within a cable exit port without passing the end of the cable therethrough.

27. A cable raceway outlet and channel assembly according to claim 10, and including an elongate cover for being releasably attached to and enclosing the interior of the cable channel segment and the slot in the cable exit ports.

28. A cable raceway outlet and channel assembly according to claim 27, wherein the cable retainer opening extends diagonally relative to the walls defining the cable access opening.

29. A cable raceway outlet and channel assembly according to claim 10, wherein each cable channel segment includes a plurality of adjacent cable exit ports, each of said cable exit ports including radiused cable-supporting surfaces extending around the periphery of inner and outer walls defining said cable outlet segment, and further wherein said plurality of adjacent cable exit ports are formed in a single elongate panel adapted for being positioned in an correspondingly-sized elongate opening in the first longitudinally-extending wall of the cable channel segment.
